(19) United States
(12) Patent Application Publication
(10) Pub. No.: US 2011/0115909 A1
(43) Pub. Date: May 19, 2011

(54) METHOD FOR TRACKING AN OBJECT THROUGH AN ENVIRONMENT ACROSS MULTIPLE CAMERAS

(76) Inventors: Stanley R. Sternberg, Ann Arbor, MI (US); John W. Lennington, Ann Arbor, MI (US); David L. McCubbrey, Ann Arbor, MI (US); Ali M. Mustafa, Dearborn, MI (US)

(21) Appl. No.: 12/946,758

(22) Filed: Nov. 15, 2010

Related U.S. Application Data
(60) Provisional application No. 61/261,300, filed on Nov. 13, 2009.

(51) Int. Cl. H04N 7/18

(52) U.S. Cl. 348/143; 348/E07.085

(57) ABSTRACT

A method and system for tracking a subject through an environment that includes collecting visual data representing a physical environment from a plurality of cameras; processing the visual data; constructing a model of the environment from the visual data; and cooperatively tracking a subject in the environment with the constructed model and processed visual data.

### CROSS-REFERENCE TO RELATED APPLICATIONS

This application claims the benefit of U.S. Provisional Application No. 61/261,300 filed 13 Nov. 2009, titled “METHOD FOR TRACKING AN OBJECT THROUGH AN ENVIRONMENT ACROSS MULTIPLE CAMERAS” which is incorporated in its entirety by this reference.

### TECHNICAL FIELD

This invention relates generally to the security surveillance field field, and more specifically to a new and useful method for tracking an object through an environment across multiple cameras in the surveillance field.

### BACKGROUND

The evolving requirements for surveillance are particularly stressing, as the effective cost of system failure has increased dramatically. A single mistake or error can result in a terrorist or illegal activity resulting in theft of property or information, destruction of property, an attack, and even worse loss of human life. Attacks can happen in a variety of locations from airplanes, trains, corporate head quarters, government building, nuclear power plants, military facilities, and any number of potential targets. Monitoring secure zones requires a tremendous amount of infrastructure: cameras, monitors, computers, networks, etc. This system then requires personnel to operate and monitor the security system. Even after all this investment and continuing operation cost, tracking a person or vehicle through an environment across multiple cameras is full of possibilities for error. Thus, there is a need in the visual surveillance field to create a new and useful method for tracking an object. This invention provides such a new and useful method.

### BRIEF DESCRIPTION OF THE FIGURES

FIG. 2 is a detailed view of an exemplary model;

FIG. 3 is a representation of a model during subject tracking;

FIG. 4 is a detailed schematic representation of conceptual components used in a model;

FIG. 5 is a schematic representation of relationships between visual data of a physical environment and modeled components; and

FIGS. 6 and 7 are schematic representations of variations of a system of a preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

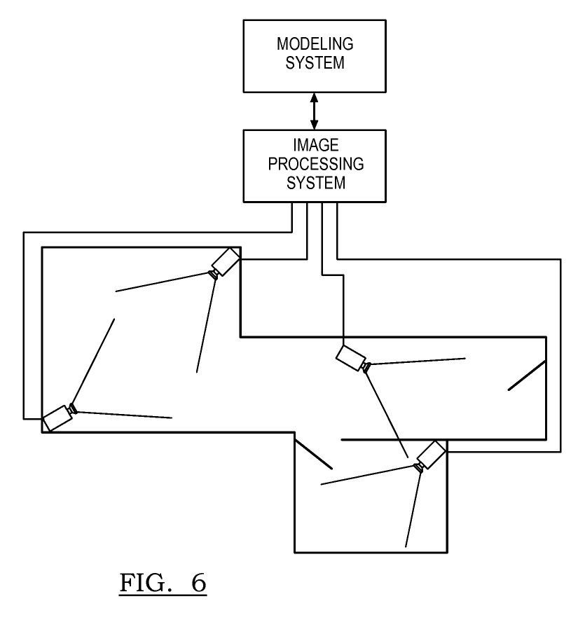

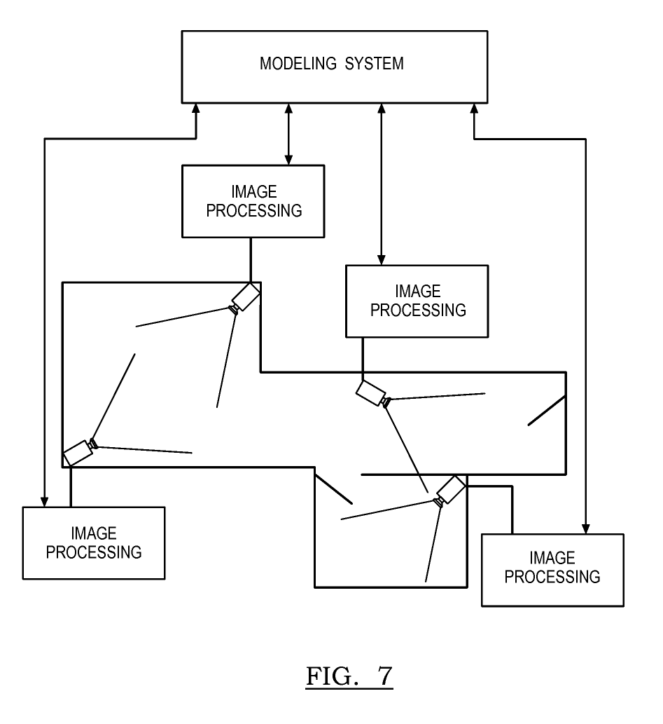

As shown in FIG. 1, a method for tracking an object through an environment of a preferred embodiment includes collecting visual data representing a physical environment from a plurality of cameras S110, constructing a model of the environment S120, processing visual data from the cameras S130, and cooperatively tracking the object with the processed visual data and the model S140. The method functions to track multiple objects through an environment, even an expansive environment with various obstructions that must be monitored with multiple cameras. The method transforms a real world data of a plurality of captured image feeds (video or images) into a computer model of objects in the environment. From the model, alarms, communication, and any suitable security measures may be initiated. The method preferably uses a 3D model of the environment to interpret, predict, and enhance the tracking capabilities of a processed video while the processed video also feeds back and updates the model. Further more the method does not rely on supplemental tracking devices such as beacons or reflectors and can be used in environments with natural object interactions such as airports, office buildings, roads, government buildings, military grounds, and other secure areas. The environment may be any suitable size and complexity. The environment is preferably an enclosed facility, but may alternatively be inside, outside, in a natural setting, multiple rooms, multiple floors, and/or have any suitable layout. The method is preferably used in settings where security and integrity of a facility must be maintained, such as at a power plant, on an airplane, or on a corporate campus, but can be used in appropriate setting. The method is preferably implemented by a system consisting of a vision system with a plurality of cameras, tracking system that includes an image processing system for processing visual data from the cameras and a modeling system (for maintaining a 3D or other suitable model of the environment with any number and type of representative components to virtually describe an environment), and a network for communicating between the elements. The cameras are preferably security cameras mounted in various locations through an environment. The cameras are preferably video cameras, but may alternatively be still images that capture images at specified times. The image processing system may be a central system as shown in FIG. 6, but may alternatively be distributed processors for individual or subgroups of cameras as shown in FIG. 7. The network preferably connects the cameras to the image processing system and connects the image processing system to the model. The method may alternatively be implemented by any suitable system.

Step S110, which includes collecting visual data representing a physical environment from a plurality of cameras, functions to monitor an environment from cameras with differing vantage points in the environment as shown in FIGS. 6 and 7. The plurality of cameras preferably capture visual data from substantially the same time. The images and video are preferably 2D images obtained by any suitable camera, but 3D cameras may alternatively be used. The images and video may alternatively be captured using other imaging devices that may capture image data other than visible information, such as Infrared cameras. The cameras preferably have a set inspection zone, which is preferably stationary, but may alternatively change if, for example, the camera is operated on a motorized mount. The arrangement of the cameras preferably allows monitoring of a majority of the environment and may additionally redundantly inspect the environment with cameras with overlapping inspection zones (preferably from different angles). The arrangement may also have areas of the environment occluded from inspection, have regions not visually monitored by a camera (the model is preferably able to predict tracking of objects through such regions), and/or only monitor zones of particular interest or importance.

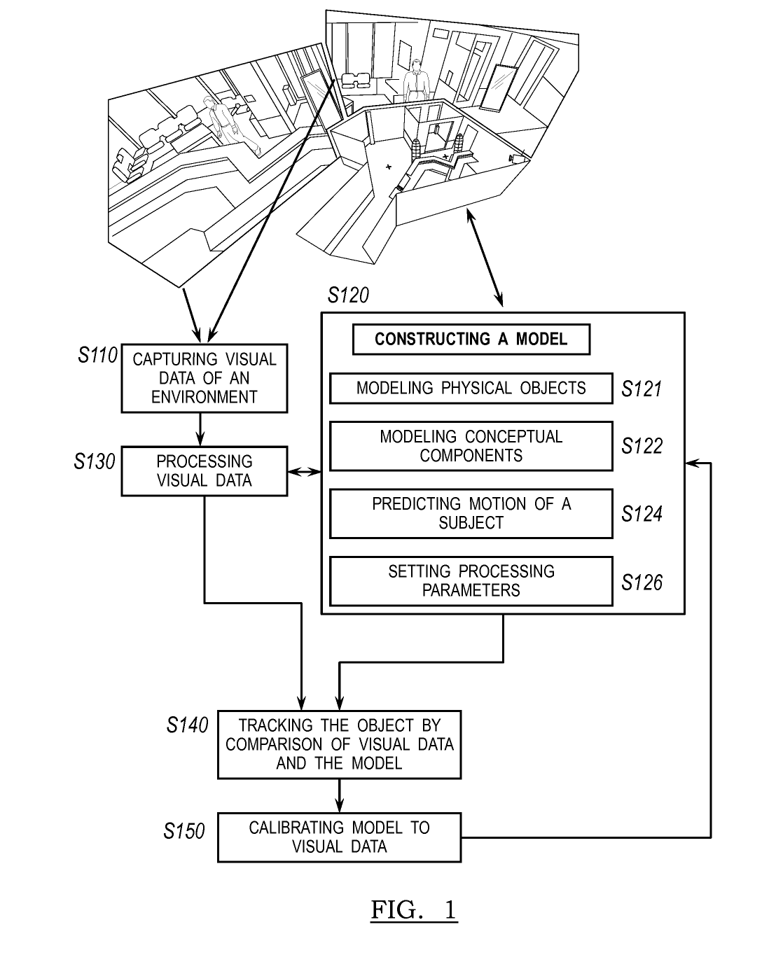

Step S120, which includes constructing a model of the environment, functions to create a virtual description of object position and layout of a physical environment. The model is preferably a 3D computer representation created in any suitable 3D modeling program as shown in FIG. 2. The model may alternatively be a 2.5D, 2D, or any suitable mathematical or programmatic description of the 3D physical environment. The model preferably considers processed visual data to maintain the integrity of the representation of objects in the environment. The model may additionally provide information to the image processing system to optimize or set the parameters of the image processing algorithms. While the visual data may only have flattened 2D image information from different vantage points through an environment, the model preferably is a unified model of the environment. The model preferably has dimensional information (e.g., 3D position) not directly evident in a single set of image data from camera (e.g., a 2D image). For example, overlapping inspection zones of two cameras may be used to calculate a three dimensional position of an object. The model further may have constructs built in that represent particular types of elements in the environment. Step S120 additionally includes the sub-step of modeling physical objects in the environment S121, including camera components, object components, and subjects of the environment. The model additionally models conceptual components including screens, shadows, and sprites, which may be used in the tracking of an object.

The modeled camera components preferably include a representation of all the cameras in the vision system (the plurality of cameras). The location and orientation of each camera is preferably specified in the camera models. Obtaining relatively precise agreement between the location and orientation of the actual camera in the environment and the camera component in the model is significant for accurate tracking of an object. The mounting bracket of a camera may additionally be modeled, which preferably includes positioning of the bracket, angles of bracket joints, periodic motion of the bracket (e.g., rotating bracket), and/or any suitable parameters of the brackets. Additionally, the focal length, sensor width, aspect ratio, and other imaging parameters of the cameras are additionally modeled. The camera components may be used in relating visual data from different cameras to determine a position of an object. Additionally, positioning information of cameras is particularly important for tracking an object as they transition between regions of the environment that are inspected by different cameras.

The modeled object components are preferably static or dynamic components. Static components of the environment are preferably permanent, non-moving objects in an environment such as structures of a building (e.g., walls, beams, windows, ceilings), terrain elevations, furniture, or any features or objects that remain substantially constant in the environment. The model additionally includes dynamic components that are objects or features of the environment that change such as escalators, doors, trees moving in the wind, changing traffic lights, or any suitable object that may have slight changes. The object components may factor into the updating of the image processing. Modeling object components preferably prevents unintentionally tracking an object that is in reality a part of the environment. For example, when trying to track an object through an environment, one algorithm may look for portions of the image that are different from the unpopulated static environment. However, if a tree were in the background waving in the wind, this image difference should not be tracked as an object. Modeling the tree as an object component is preferably used to prevent this error. Additionally, static components in the environment can be used to understand when occlusions occur. For example, by modeling a counter, a person walking in behind the counter may be properly tracked because of the modeled object can provide an understanding that a portion of the person may not be visible because of the counter.

The modeled subjects of the environment are preferably the moving objects that populate an environment. The subjects are preferably people, vehicles, animals, and/or objects that convey an object. The subjects are preferably the objects that will be tracked through an environment. However, some subjects may be left untracked. Some subjects may be selectively tracked (as instructed by a security system operator). Subjects may alternatively be automatically tracked based on subject-tracking rules. The subject-tracking rules may include a subject being in a specified zone, moving in a particular way (too fast, wrong direction, etc.), having a particular size, image recognition trigger, or based on any suitable rule. Additionally, a time limit may be implemented before a subject is tracked to prevent automatic tracking caused by the motion of random objects. The model preferably represents the subjects by an avatar, which is a dynamic representation of the subject. The avatars preferably are positioned in the model as determined from the video data of the physical environment. Body or detailed movements of a subject are preferably not modeled, but course behavior descriptions such as standing, walking, sitting, or running may be represented. A subject component may include descriptors such as weight, inertia, friction, orientation, position, steering, braking, motion capabilities (e.g., maximum speed, minimum speed, turning radius), environment permissions (areas allowed or actions allowed in areas of the environment), and/or any suitable descriptor. The descriptors are preferably parameters determining possible interactions and representation in an environment.

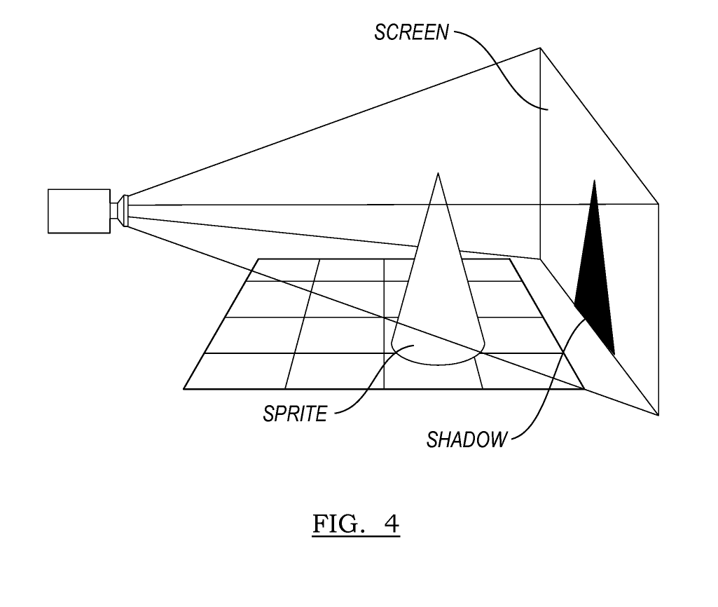

The sub-step of modeling conceptual components S122 functions to facilitate the computation of tracking objects through 3D geometry. A conceptual component is preferably virtually constructed and associated with the imaging and modeling of the environment, but may not physically be an element in the environment. The conceptual components preferably include screens, shadows, and sprites as shown in FIG. 4. A screen is preferably a planar area that would exist if the image sensed by a camera was projected and enlarged onto a rectangular plane oriented normal to and centered on the camera axis. The distance between the screen and the camera preferably positions the screen outside the bounding box of the rest of the environment (in the model). There is preferably one screen for every camera. The screen may additionally be any size or shape according to the imaging of the camera. For example a 360-degree camera may have a ring shaped screen and a fisheye lens camera may have a spherically curved screen. The screen is preferably used to generate the shadow constructs. A sprite is a representation of a tracked subject. Sprites function as dynamic components of a model and have associated kinematic representations. The sprite is preferably associated with a subject construct described above. The sprite is preferably positioned, sized, and oriented in the model according to the visual information for the location of the subject. A sprite may include subject descriptors such as weight, inertia, friction, orientation, position, steering, braking, motion capabilities (e.g., maximum speed, minimum speed, turning radius), environment permissions (areas allowed or actions allowed in areas of the environment), and/or any suitable descriptor. The descriptors of a sprite are preferably from an associated subject or subject type. An alert response is preferably activated upon violation of an environment permission. An alert response may be sounding an alarm, displaying an alert, enrolling a subject in tracking, and/or any suitable alarm response. These sprite descriptors may be acquired from previous tracking history of the subject or may applied from the type of subject construct. For example a different default sprite will be applied to a human than to a car. The type of behavior and motion of an object is preferably predicted from the subject descriptors. The sprites may have geometric representations for 3D modeling, such as a cylinder or a box. A sprite may additionally have a shadow. The shadow of the sprite may additionally be interpreted as a region in the environment where the subject is likely to be within the visual data. Processing algorithms may additionally be selected for detailed examination based on the size, location, and orientation of the sprite shadows. The shadows are preferably representations of areas occluded from the view of the camera. A shadow component is generated by simulating a beam projection from a camera onto a screen. Model components that are in the beam projection cast a shadow onto the screen. The cast shadows are the shadow components. A sprite will preferably cast a shadow component onto a screen if not occluded by some other model construct and if within the inspection zone of a camera. The shadows preferably follow the motion of the model components. A shadow functions to indicate areas of a video image where a tracked subject may be partially or totally occluded by a second object in the environment. This information can be used for tracking an object partially or totally out of sight as is described below.

Additionally, Step S120 preferably includes predicting motion of a subject S124, which functions to model the motion of a subject and calculate future position of a subject from previous information. The motion is preferably calculated from descriptors of the sprite representing a subject. The previous direction of the subject, motion patterns, velocity, and acceleration and/or any other motion descriptors are preferably used to calculate a trajectory and/or position at a given time of a subject. The model preferably predicts the location of the subject without current input from the vision system. Furthermore, motion through unmonitored areas may be predicted. For example if a subject leaves the inspection zone of a camera on one end of a hallway, the velocity of the subject may be used to predict when the subject should appear in an inspection zone on the other end of the hallway. The motion prediction may additionally be used to assign a probability of where a subject may be found. This may be useful in situations where a tracked subject is lost from visual inspection, and a range of locations may be inspected based on the probability of the location of the subject. The model may additionally use the motion predictions to construct a blob prediction. A blob prediction is a preferred pattern detection process for the images of the cameras and is described more below. The model preferably constructs the predictions such that the current prediction is compared to current visual data. If the model predictions and the visual data are not in agreement to a satisfactory level, the differences are preferably resolved by either adjusting the dynamics of the tracked subject to match the processed visual data or ignoring the vision visual data as incompatible with the dynamics of a tracked subject of a particular type and behavior.

Additionally, Step S120 preferably includes setting processing parameters based on the model S126, which functions to use the model to determine the processing algorithms and/or settings for processing visual data. Using the model to predict appropriate processing algorithms and settings allows for optimization of limited processing resources. As described above, static and dynamic object components, shadow components, subject motion predictions, blob predictions, and/or any suitable modeled component may be used to determine processing parameters. The shadows preferably determine processing parameters of the camera associated with the screen of the shadow. The processing parameters are preferably determined based on discrepancies between the model and the visual data of the environment. The processing operations are preferably set in order to maintain a high degree of confidence in the accuracy of the model of the tracked subjects.

Step S130, which includes processing images from the cameras, functions to analyze the image data of the vision system for tracking objects. The processed image data preferably provides the model with information regarding patterns in the video imagery. The processing algorithms may be frame by frame or frame-difference bases. The algorithms used for processing of the image data may include connected component analysis, background subtraction, mathematical morphology, image correlation, and/or any suitable image tracking process. The processing algorithms include a set of parameters that determine the particular behavior on the processed image. The processing parameters are preferably partially or fully set by the model. The visual data from the plurality of cameras is preferably acquired and processed at the same time. The visual data from the cameras is preferably individually processed. The processed results are preferably chain codes of image coordinates for binary patterns that arise after processing image data. The binary pattern preferably has coordinates to locate specific features in each pattern.

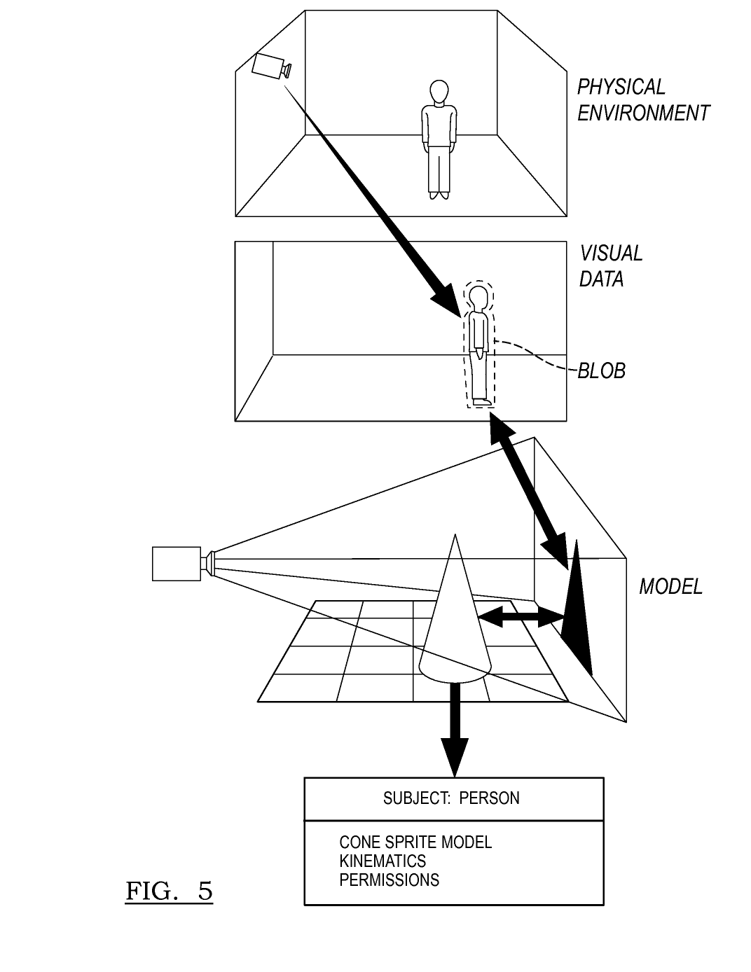

The patterns detected in the processed visual data are preferably in the form of binary connected regions, also referred to as blobs. Blob detection preferably provides an outline and a designating coordinate to denote the location of the distinguishing features of the blob. The outline of detected blobs preferably corresponds to the outline of a subject. As shown in FIG. 5, blobs from the visual data are preferably matched to shadows occurring in corresponding locations in the image and screen. The shadows themselves have an associated sprite for a particular subject component. Thus blobs are preferably mapped to a modeled subject or sprite. If no shadow component exists for a particular blob, a sprite and an associated subject may be added to the model. Blobs, however, may additionally split into multiple blobs, intersect with blobs associated with a second subject, or occur in an image where there is no subject. The mapping of blobs to sprites is preferably maintained to adjust for changes in the detected blobs in the visual data. In blob tracking, pixels belonging to a subject are preferably detected by the vision system through background subtraction or alternatively through frame differencing or any suitable method. In background subtraction, the vision system keeps an updated version of the stationary portions of the image. When a subject moves across the background, the foreground pixels of the subject are detected where they differ from the background. In frame differencing, subject pixels are detected when the movement of the subject causes pixel differences in subtracted concurrent or substantially concurrent frames. Pixels detected by background subtraction or frame differencing, or any suitable method are preferably combined in blob detection by conditionally dilating the frame difference pixels over the foreground pixels. This preferably functions to prevent gradual illumination changes in an image to register as detected subjects and to allow subjects that only partially move (e.g., waving arm) to be detected. In an alternative variation image correlation may be used in place of or with blob detection. Image correlation preferably generates a binary region that represents the image coordinates where the image correlation function exceeds a threshold. The correlation similarly detects a binary region and a distinguishing coordinate.

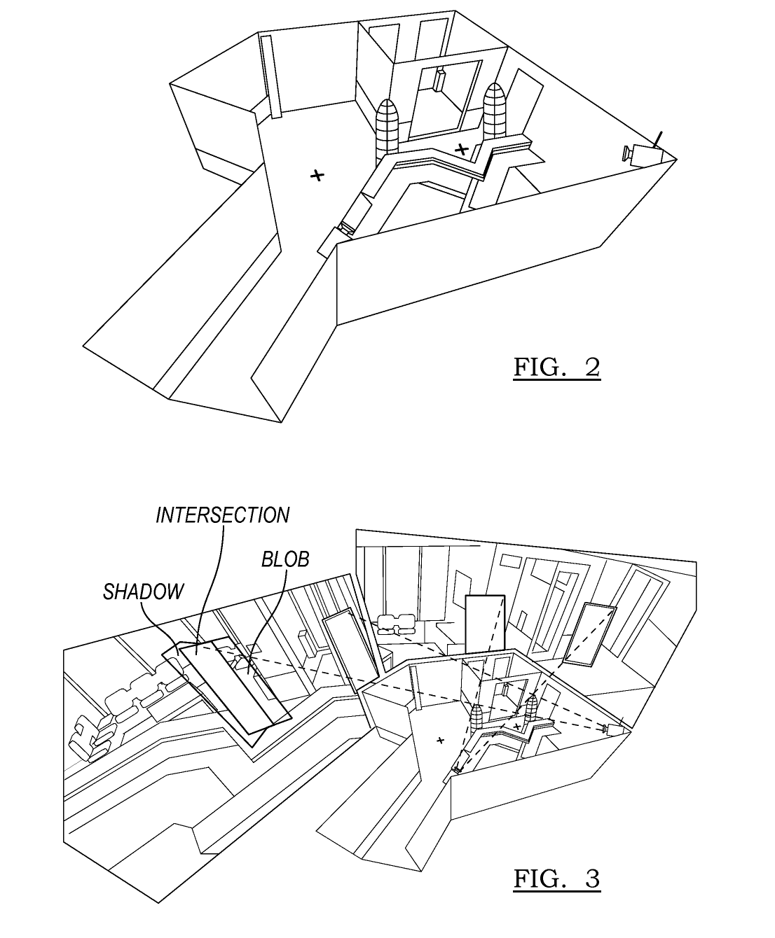

Step S140, which includes cooperatively tracking the object by comparison of the processed video images and the model, functions to compare the model and processed video images to determine the location of a tracked subject. The model preferably moves each sprite to a predicted position and constructs shadows of each sprite on each screen. The shadows are preferably flat polygons in the model as are the blobs that have been inputted from the vision system and drawn on the screens. As shown in FIG. 3, shadow and sprite spatial relationships are preferably computed in the model by polygon union and intersection, inclusion, convex hull, etc. The primary spatial relationship between a shadow and a blob is association, where a blob becomes associated with a particular sprite. For example, if a shadow intersects a blob, then the blob becomes associated with a sprite associated with the shadow. In that case, the designating coordinates of the blob become associated with a given sprite. The model preferably associates as many vision system blobs with sprites as possible. Unassociated blobs are preferably further examined by special automated enrollment software that can initiate new subject tracks. Each sprite preferably examines the associated blobs from a given camera. From this set, a single blob is chosen, for example, the highest blob. The designating coordinate of the blob is then preferably used to construct a projection for the sprite in the given camera. If the sprite in the model is perfectly (or satisfactory) aligned with the tracked subject in the facility then the projection preferably passes through the corresponding feature of the sprite, (e.g., the peak of a conical roof of a sprite). The set of all projections of a sprite represent multiple viewpoints of the same subject. From these multiple projections the model preferably selects those projections, which yield a most likely estimate of the tracked subject's actual position in the facility. If that position is consistent with the model and the sprite kinematics (e.g., the subject is not walking through a wall or instantaneously changing direction), then the sprite position is updated. Otherwise, the model searches the sprite projections for subsets of projections that yield consistency. If none is found, the predicted location of the sprite is not updated by the vision system.

Additionally the method may include the step of calibrating alignment of the model and the visual data S150, which functions to modify the static model to compensate for discrepancies between the model and the visual data. Imperfect alignment of cameras in an environment may account for error during the tracking process and this step preferably accounts for camera model components as well to lessen the source of error. Specific, well-measured features in the 3D model that are highly visible in the camera are preferably selected to be calibration features. The calibration process preferably includes simulating the camera image in the model and aligning the simulated image to the camera image at all the specified calibration features. The camera-bracket-lens geometry of the camera model is preferably adjusted until the simulation and video image align at the specified features. Additionally, a mesh distortion may be applied within the model to account for optical properties or aberrations of camera lenses that cause distortion of visual data. The 3D model's camera-bracket-lens geometry can be adjusted manually or automatically. Automatic adjustment requires the application of an appropriate optimization algorithm, such as gradient hill climbing. For camera calibration to be accurate, the model's representation of the specified calibration features must be accurately located in 3D. Additionally, the position of the camera being calibrated in the model must be known with high precision. If camera and feature locations are accurately known in three dimensions, then a camera can preferably be calibrated using only two specified features in the image of each camera. If there is uncertainty of the camera's height, then the camera can preferably be calibrated using three specified features. Camera and feature locations are best determined by direct measurement. Modern surveying techniques preferably yield satisfactory accuracies for camera calibration in situations requiring a high degree of tracking accuracy.

As a person skilled in the art will recognize from the previous detailed description and from the figures and claims, modifications and changes can be made to the preferred embodiments of the invention without departing from the scope of this invention defined in the following claims.

We claim:

1. A method for tracking a subject through an environment comprising:
collecting visual data representing a physical environment from a plurality of cameras;
processing the visual data;
constructing a model of the environment from the visual data; and
cooperatively, tracking a subject in the environment with the constructed model and processed visual data.

2. The method of claim 1, wherein the processing of collected visual data is based on the constructed model.

3. The method of claim 2, wherein the model is a 3D model of subjects in a simulation of the environment, wherein the model of the environment is preconfigured.

4. The method of claim 1, wherein constructing a model of the environment includes modeling camera components, object components of the environment, and subject components that are subject to tracking.

5. The method of claim 4, wherein object components of the environment include static and dynamic object components.

6. The method of claim 4, wherein the subject models have associated environment permissions defining the interactions of the modeled physical object in the environment of the model, and further including activating an alert response upon violation of environment permissions of a subject.

7. The method of claim 6, wherein the environment permission is a defined portion of the environment that a subject may be located.

8. The method of claim 4, wherein constructing a model further includes modeling conceptual components that are used to relate visual data and the model during tracking.

9. The method of claim 8, wherein the conceptual components include a sprite, a screen, and a shadow and comprising:
modeling a subject position in the environment with a sprite;
modeling visual data as a projection from a camera onto a surface normal and displaced from a position of the camera in the environment;
simulating a projection from the camera position to the sheet; and
identifying a shadow cast by the sprite interrupting the projection on the sheet.

10. The method of claim 9, wherein cooperatively tracking includes comparing shadows to processed image data.

11. The method of claim 10, wherein processing visual data includes detecting a binary connected region of an image of the visual data; and wherein cooperatively tracking includes associating the binary connected region with a shadow of a sprite and updating sprite position according to the position of the binary connected region in the visual data.

12. The method of claim 11, wherein position of a sprite is updated if the updated position satisfies kinematic properties of the subject assigned to the sprite.

13. The method of claim 4, wherein constructing a model further includes predicting motion of a subject.

14. The method of claim 13, wherein predicting motion includes predicting motion of a sprite through a portion of the environment with no visual data by using calculating motion from kinematic properties of the subject.

15. The method of claim 4, further comprising defining a condition in the model for automatic enrollment of subject tracking; and wherein collaboratively tracking includes automatically selecting a subject for tracking upon satisfying the defined condition.

16. The method of claim 4 further comprising calibrating the model and the visual data by adjusting the modeled camera components to maximize alignment of the model and the visual data the camera associated with the camera component.

17. A system for tracking a subject in an environment comprising:
an imaging system to capture image data with a plurality of cameras arranged in the environment;
a tracking system for tracking a subject in an environment that includes:
an image processing system for processing the captured image data and in communication with a modeling system
a modeling system that maintains a model of the environment according to the processed image data and communicates image processing updates to the image processing system

18. The system of claim 17 wherein the image processing system includes an image processor for each camera of the plurality of cameras.

19. The system of claim 17, wherein the plurality of cameras are distributed in an environment with at least two cameras having at least partially overlapping inspection zones

20. The system of claim 17, wherein the modeling system includes a model of camera object components and subject component assigned to a sprite; wherein the sprite is associated with a shadow resulting from a projection onto a modeled sheet; and the imaging processing system includes calculated binary connected regions of visual data that can be associated with the shadows for tracking.
